(19) United States
(12) Patent Application Publication
(10) Pub. No.: US 2015/0217851 A1
(43) Pub. Date: Aug. 6, 2015

(54) WING CONFIGURATION

(71) Applicant: Richard Kelso, Adelaide (AU)

(72) Inventor: Richard Kelso, Adelaide (AU)

(21) Appl. No.: 14/421,838

(22) PCT Filed: Aug. 16, 2013
(86) PCT No.: PCT/AU2013/000916

§ 371 Date: Feb. 15, 2015

(30) Foreign Application Priority Data
Aug. 16, 2012 (AU) 2012903527

(51) Int. Cl. B64C 3/14; F01D 5/14

(52) U.S. Cl. CPC B64C 3/14; F01D 5/141; B64C 2003/146; B64C 2003/148; B64C 2003/142

(57) ABSTRACT

This invention relates to a wing comprising a generally aerofoil (or airfoil) shaped body having a leading edge, a trailing edge, a span, and first and second major surfaces extending between the leading edge and the trailing edge, where at least one of said first or second major surfaces comprises cyclic spanwise variations at or near the leading edge thereof, but not the trailing edge thereof. In preference, the cyclic spanwise variations extend substantially chordwise from at or near the leading edge, progressively diminishing as they extend chordwise so as to disappear at or before reaching the trailing edge of the wing.

### PRIORITY DOCUMENT

The present application claims priority from:

Australian Provisional Patent Application No 2012903527 titled “IMPROVED WING CONFIGURATION” and filed on 16 Aug. 2012. The content of this application is hereby incorporated by reference in its entirety.

### TECHNICAL FIELD

The present invention relates to wings or blades for apparatus which employ these, and of the type which generally employ an aerofoil (or airfoil) cross-sectional shape. For the purpose of this specification, the terms “wing” and “blade” can be considered interchangeable.

### BACKGROUND

Conventional wings of streamlined aerofoil shape have a cross-sectional shape that is substantially constant across a span of the wing. These conventional wings perform well at low to moderate angles of attack, but at higher angles of attack (or increased loading) separation and aerodynamic stall occur.

Various attempts have been made to improve, amongst other things, the efficiency and stall characteristics of wings.

Traditional methods employed to improve wing performance include (leading-edge) slats, (trailing-edge) flaps, strakes and vortex generators. Slats and flaps are devices that are used to increase wing area and camber (curvature) and are usually deployed by large aircraft during take-off and landing, and low-speed manoeuvres. Strakes and vortex generators are used to keep the flow attached over the low-pressure side of the wing, but these generate additional drag on the wing, and so are generally small in size and hence are of limited benefit at large angles of attack. None of these reduce induced drag.

Previous attempts to improve wing performance by other means can be found in U.S. Pat. No. 6,431,498, which discloses a wing comprising scallops in the leading edge thereof, and ridges which terminate at the trailing edge. It was proposed that such wing modifications would lead to a reduced pressure at the protrusions, leading to an increase in lift and a reduction in drag, however, their effectiveness has since been challenged by newer studies.

It is against this background and the problems and difficulties associated therewith that the present invention has been developed.

Certain objects and advantages of the present invention will become apparent from the following description, taken in connection with the accompanying drawings, wherein, by way of illustration and example, an embodiment of the present invention is disclosed.

### SUMMARY

According to a first aspect, there is provided a wing “form” for relative movement with respect to a fluid, the wing comprising a leading edge, a trailing edge, a span, and means for effecting a cyclic spanwise variation in a force generated in a sense (direction) substantially perpendicular to a direction of relative movement.

Depending on the application and orientation of the wing, this force may be anyone of lift, down force, or an otherwise directed driving force resulting in movement of the fluid (as in the case of a fan, propeller or the like) or movement of the wing (as in the case of a turbine blade or the like). In one form, the means effects a cyclic variation in the lift per unit span (or wing loading) of the wing.

In one form, a lower pressure is created on one side of the wing than on the other, and the means effects said spanwise variation on the lower pressure side only.

In one form, the wing comprises first and second major surfaces extending between the leading edge and the trailing edge, and said means comprises cyclic spanwise variations of at least one of said first and second major surfaces.

In one form, at least one of said first or second major surfaces comprises cyclic spanwise variations at or near the leading edge thereof, but not the trailing edge thereof.

In one form, the cyclic spanwise variations extend substantially chordwise from at or near the leading edge, progressively diminishing as they extend chordwise so as to disappear at or before

In a further aspect, the invention may be said to reside in a wing “form” for movement through a fluid, the wing comprising a leading edge, a trailing edge, a span, first and second major surfaces extending between the leading edge and the trailing edge, where at least one of said first or second major surfaces comprises cyclic spanwise variations thereof.

In one form, one major surface comprises said cyclic spanwise variations thereof, and the other major surface does not.

In one form, both of the first and second major surfaces comprise said cyclic spanwise variations thereof.

In one form, said cyclic spanwise variation form peaks and troughs in the or each surface.

In one form, said peaks and troughs extend substantially chordwise.

In one form, transition between adjacent peaks and troughs is substantially smooth.

In one form, transition between adjacent peaks and troughs is substantially linear.

In one form, transition between adjacent peaks and troughs is substantially stepwise.

In one form, for a stepwise transition the wing is substantially linear between steps.

In one form, all steps are either of steps up or down spanwise. In an alternative, up and down steps alternate spanwise.

In one form, peaks and troughs in each of the first and second major surfaces are synchronized or in phase with each other.

In one form, peaks and troughs in each of the first and second major surfaces are out of phase with each other.

In one form, peaks in one major surface are synchronized or in phase with troughs in the other major surface.

In one form, the cyclic spanwise variations are variations in angle of attack.

In one form, the cyclic spanwise variations are variations in maximum wing section thickness.

In one form, the cyclic spanwise variations are variations in camber.

In one form, the wing comprises a plurality of wavelengths (ie the distance over which the wings spanwise form repeats) of spanwise variation.

In one form, the wavelength for each spanwise variation is substantially constant. In an alternative the wavelength for each spanwise variation varies spanwise.

In a further aspect, the invention may be said to reside in a wing comprising a generally aerofoil (or airfoil) shaped body having a leading edge, a trailing edge, a span, and first and second major surfaces extending between the leading edge and the trailing edge, where at least said leading edge comprises cyclic spanwise variations thereof, each of which extend substantially chordwise therefrom.

In a further aspect, the invention may be said to reside in a wing comprising a first form comprising a generally aerofoil (or airfoil) shaped body having a leading edge, a trailing edge, a span, and first and second major surfaces extending between the leading edge and the trailing edge, and a second form which further comprises cyclic spanwise variations of at least one of said first or second major surfaces, the wing further comprising means for selectively changing between the first and second forms.,

In one form, this means for selectively changing between the first and second forms may include any one or more of shape-memory alloys, pneumatic actuators and/or electro-mechanical actuators. Another means is by the use of a leading-edge slat which allows the wing to change between first and second forms when it is deployed.

In one form, the wing is swept, in which case, the waves may be aligned with the direction of flow (which is parallel with the wing's chord in any event), not the leading edge). In an alternative, the wing is unswept.

In one form, the wing is tapered. In an alternative, the wing untapered.

A detailed description of one or more embodiments of the invention is provided below along with accompanying figures that illustrate by way of example the principles of the invention. While the appended claims and the invention encompasses numerous alternatives, modifications and equivalents. For the purpose of example, numerous specific details are set forth in the following description in order to provide a thorough understanding of the present invention.

The present invention may be practiced according to the claims without some or all of these specific details. For the purpose of clarity, technical material that is known in the technical fields related to the invention has not been described in detail so that the present invention is not unnecessarily obscured.

### BRIEF DESCRIPTION OF DRAWINGS

Embodiments of the present invention will be discussed with reference to the accompanying drawings wherein:

FIG. 1 is a perspective view of a conventional wing;

FIG. 2 is a perspective view of a wing according to a first embodiment of the invention;

FIG. 3 is a perspective view of a wing according to a second embodiment of the invention;

FIG. 4 is a front view of a wing according to a further embodiment of the invention;

FIG. 4(a) is a sectional view through the wing of FIG. 4;

FIG. 5 is a front view of a wing according to a further embodiment of the invention;

FIG. 5(b) is a sectional view through the wing of FIG. 5;

FIG. 6 is a front view of a wing according to a further embodiment of the invention;

FIG. 6(c) is a sectional view through the wing of FIG. 6;

FIG. 7 is a front view of a wing according to a further embodiment of the invention;

FIG. 7(d) is a sectional view through the wing of FIG. 7;

FIG. 8(e) is a sectional view through the wing of FIG. 8;

FIG. 9 is a front view of a wing according to a further embodiment of the invention;

FIG. 9(f) is a sectional view through the wing of FIG. 9;

FIG. 10 is a front view of a wing according to a further embodiment of the invention;

FIG. 10(g) is a sectional view through the wing of FIG. 10;

FIG. 11 is a front view of a wing according to a further embodiment of the invention;

FIG. 11(a) is a sectional view through the wing of FIG. 11;

FIG. 12 is a front view of a wing according to a further embodiment of the invention;

FIG. 12(b) is a sectional view through the wing of FIG. 12;

FIG. 13 is a front view of a wing according to a further embodiment of the invention;

FIG. 13(c) is a sectional view through the wing of FIG. 13;

FIG. 14 is a front view of a wing according to a further embodiment of the invention;

FIG. 14(d) is a sectional view through the wing of FIG. 14;

FIG. 15 is a front view of a wing according to a further embodiment of the invention;

FIG. 15(e) is a sectional view through the wing of FIG. 15;

FIG. 16 is a front view of a wing according to a further embodiment of the invention;

FIG. 16(f) is a sectional view through the wing of FIG. 16;

FIG. 17 is a front view of a wing according to a further embodiment of the invention;

FIG. 17(g) is a sectional view through the wing of FIG. 17:

FIG. 18 is a perspective view of a wing according to a further embodiment of the invention;

FIG. 19 is a perspective view of an impeller according to a first embodiment of the invention;

FIG. 20 is a perspective view of an impeller according to a further embodiment of the invention;

FIG. 21 is a perspective view of an impeller according to yet a further embodiment of the invention; and

FIG. 22 is a perspective view of a centrifugal fan impeller.

In the following description, like reference characters designate like or corresponding parts throughout the figures.

### DESCRIPTION OF EMBODIMENTS

Referring now to FIG. 1, where there is illustrated a conventional wing, as discussed in the background of this specification. For reference purposes, the wing span can be seen at S, and the wing chord can be seen at ‘c’.

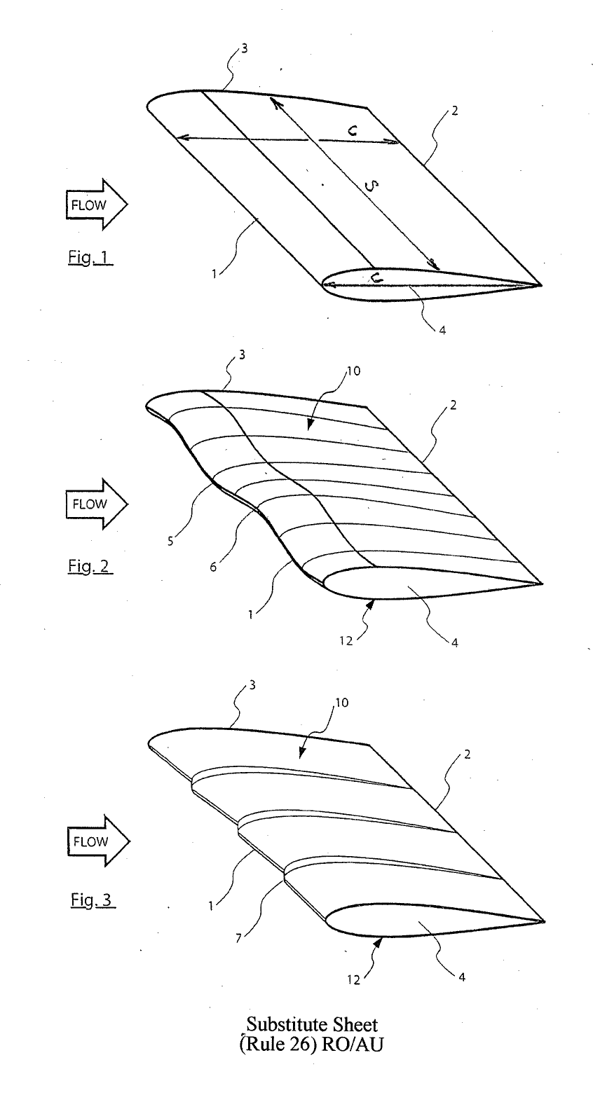

Referring now to FIG. 2, where there is illustrated a wing whose leading edge 1 and trailing edge 2 are relatively straight when viewed in plan (mutually normal to the flow direction and longitudinal axis of the wing), and both the cross-sectional shape and the local angle of attack of the wing vary cyclically along the span of the wing (ie spanwise) so that at least one cycle of variation occurs between the root 3 and the tip 4. This results in the leading edge 1 of the wing rising and falling cyclically from root 3 to tip 4, such that regions of high angle of attack 6 and regions of low angle of attack 5 are produced, while the trailing edge 2 is substantially straight.

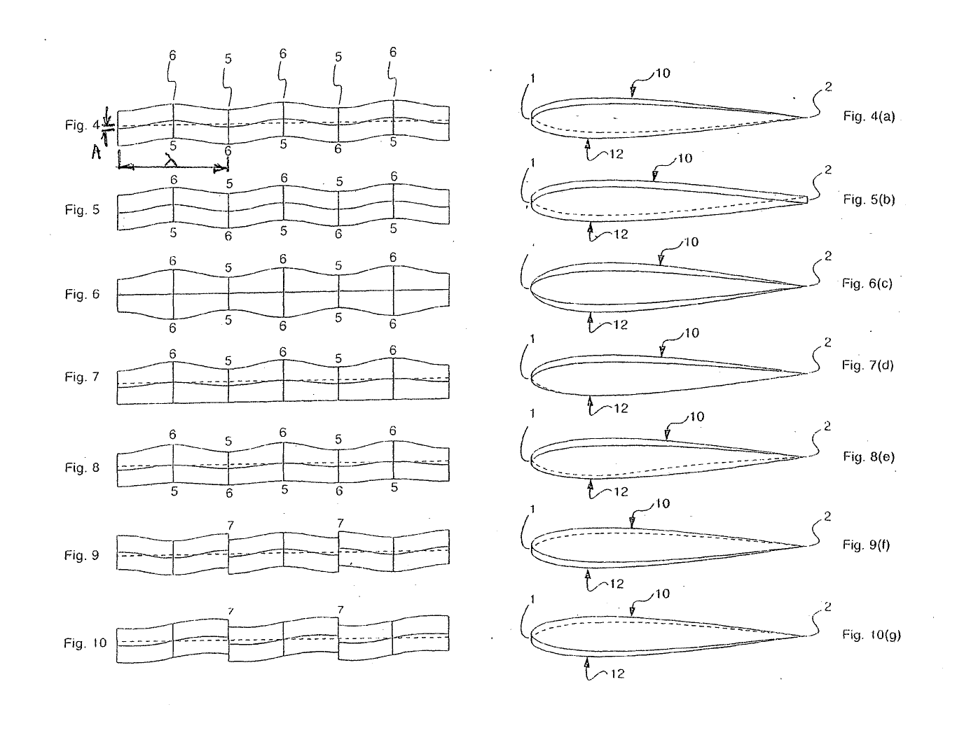

FIGS. 4 and 4(a) are representative of forward edge and cross-sectional views through the wing illustrated in FIG. 2. It will be apparent from FIG. 4(a) in particular, that the above described cyclic spanwise variations of the wing illustrated in FIGS. 2, 4 and 4(a) extend substantially chordwise from at or near the leading edge 1, progressively diminishing as they extend chordwise so as to

[symbol]

Referring now to FIG. 3, where there is illustrated a wing whose leading edge 1 and trailing edge 2 are relatively straight when viewed in plan (mutually normal to the flow direction and longitudinal axis of the wing). In this embodiment the local angle of attack of the wing varies in a step-wise cyclic manner along the span of the wing so that at least one cycle of variation occurs between the root 3 and the tip 4. This results in the leading edge 1 of the wing rising and falling cyclically but step-wise from root 3 to tip 4, while the trailing edge 2 is substantially straight. Here the steps are formed by discontinuities in sectional shape occurring at positions (steps) 7, such that regions of high angle of attack and regions of low angle of attack are produced.

FIGS. 16 and 16(f) are representative of forward edge and cross-sectional views through the wing illustrated in FIG. 3. It will be apparent from FIG. 16(f) in particular, that the above described cyclic spanwise variations of the wing illustrated in FIGS. 3, 16 and 16(f) extend substantially chordwise from at or near the leading edge 1, progressively diminishing as they extend chordwise so as to disappear at or before reaching the trailing edge 2 of the wing.

Referring now to FIGS. 4 through 10, where the spanwise variations in wing shape are such that each segment of the cycle blends smoothly and progressively (including sinusoidally) into the next across the span of the wing. For reference purposes, the amplitude of the wing illustrated in FIG. 4 is denoted ‘A’, and the wavelength is denoted ‘λ’.

Referring again to FIGS. 4 and 4(a), where the cyclic spanwise variations form peaks 6 and troughs 5 in both (ie upper and lower) major surfaces 10 and 12, along with the leading edge 1 (but not the trailing edge 2), and where peaks 6 in one major surface are synchronized or in phase with troughs 5 in the other major surface.

Referring now to FIGS. 5 and 5(b), wherein the cyclic spanwise variations are lateral displacements of wing section. These cyclic spanwise variations form peaks 6 and troughs 5 in both (ie upper and lower) major surfaces 10 and 12 of the wing, along with both the leading and trailing edges 1 and 2 of the wing, where peaks 6 in one major surface are synchronized or in phase with troughs 5 in the other major surface.

Referring now to FIGS. 6 and 6(c), wherein the cyclic spanwise variations are symmetrical changes in the cross-sectional thickness of the wing. These cyclic spanwise variations form pairs of opposing peaks 6 and pairs of opposing troughs 5 in both major surfaces 10 and 12 of the wing, resulting in a wing section which alternates between thick and thin sections. It will be apparent from FIGS. 6 and 6(c) extend substantially chordwise, but disappear at or before reaching the trailing edge 2 of the wing.

Referring now to FIGS. 7 and 7(d) wherein the cyclic spanwise variations are asymmetric changes in cross-sectional thickness. Here the cyclic spanwise variations form peaks 6 and troughs 5 in the first (or upper) major surface 10, while the second (or lower) major surface 12 incorporates no such cyclic spanwise variations. It will be apparent from FIG. 7(d) in particular, that the above described cyclic spanwise variations of the wing illustrated in FIGS. 7 and 7(d) extend substantially chordwise, but disappear at or before reaching the trailing edge 2 of the wing.

Referring now to FIGS. 8 and 8(e) wherein the cyclic spanwise variations are changes in section camber. Here the cyclic spanwise variations form peaks 6 and troughs 5 in the first (or upper) major surface 10 which are more pronounced than the peaks 6 and troughs 5 in the second (or lower) major surface 12. It will be apparent from FIG. 8(e) in particular, that the above described cyclic spanwise variations of the wing illustrated in FIGS. 8 and 8(e) extend substantially chordwise, but disappear at or before reaching the trailing edge 2 of the wing.

Referring now to FIGS. 9 and 9(f), wherein the wing is similar to the wing of FIG. 4, differing in that the wing of FIGS. 9 and 9(f) further comprises steps 7 in wing section which alternate between steps up and down spanwise. It will be apparent from FIG. 9(f) in particular, that the above described cyclic spanwise variations of the wing illustrated in FIGS. 9 and 9(f) extend substantially chordwise, but disappear at or before reaching the trailing edge 2 of the wing.

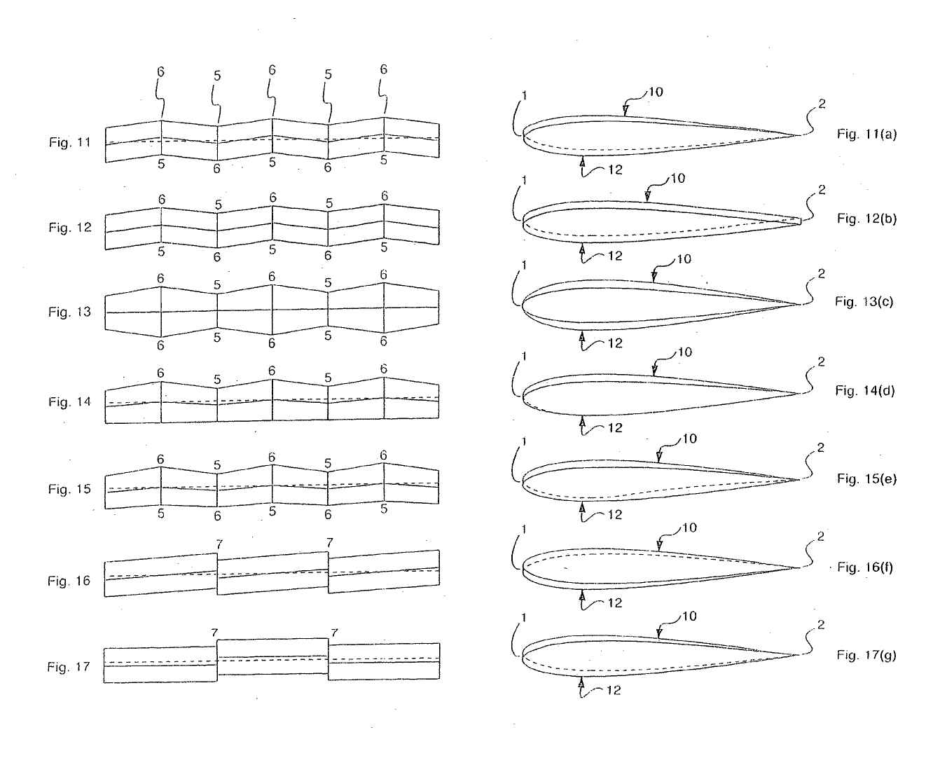

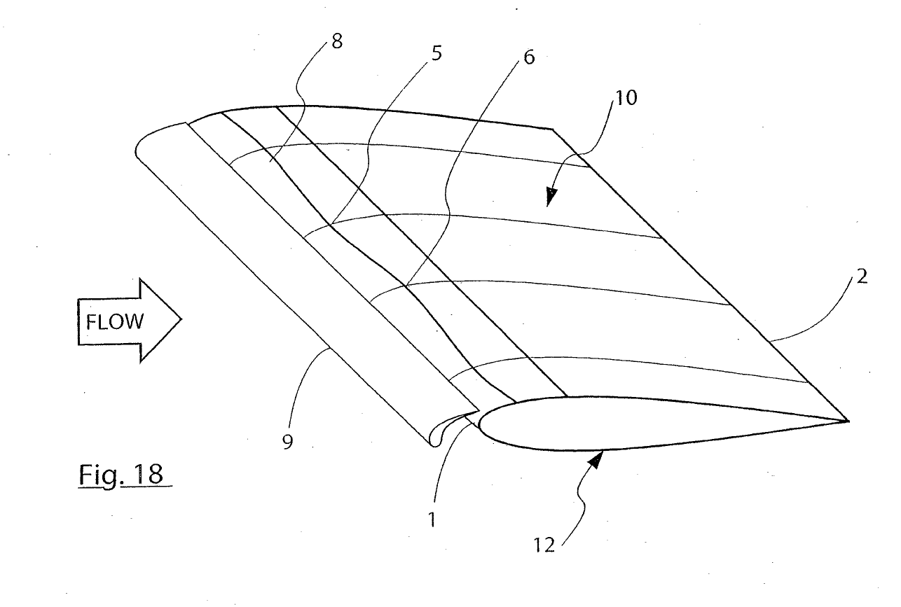

Referring now to FIGS. 10 and 10(g), wherein the wing comprises steps 7 in wing section, and each segment of wing defined between respective steps 7 spanwise is substantially identical or at least physically similar, and curved in the fashion described above for one half of a wavelength thereof. It will be apparent from FIG. 10(g) in particular, that the above described cyclic spanwise variations of the wing illustrated in FIGS. 10 and 10(g) extend substantially chordwise, but disappear at or before reaching the trailing edge 2 of the wing.

Referring now to FIGS. 11 through 17, where the cyclic spanwise variations in wing shape are such that each segment of the cycle occurs at an abrupt discontinuity.

Referring now to FIGS. 11 and 11(a), wherein the cyclic spanwise variations are changes in angle of attack. These cyclic spanwise variations form peaks 6 and troughs 5 in both (ie upper surface. It will be apparent from FIG. 11(a) in particular, that the above described cyclic spanwise variations of the wing illustrated in FIGS. 11 and 11(a) extend substantially chordwise, but disappear at or before reaching the trailing edge 2 of the wing.

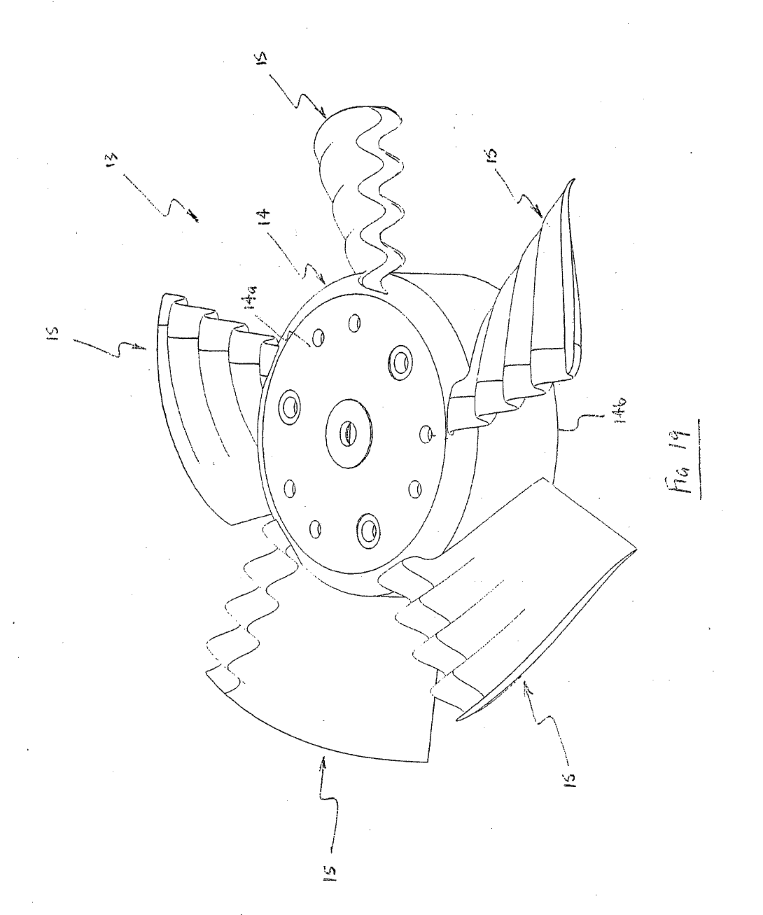

Referring now to FIGS. 12 and 12(b), wherein the cyclic spanwise variations are lateral displacement of the section. These cyclic spanwise variations form peaks 6 and troughs 5 in both (ie upper and lower) major surfaces 10 and 12 of the wing, along with the leading and trailing edges 1 and 2 of the wing, where peaks 6 in one major surface are synchronized or in phase with troughs 5 in the other major surface.

Referring now to FIGS. 13 and 13(c), wherein the cyclic spanwise variations are symmetrical changes in cross-sectional thickness. These cyclic spanwise variations form opposing peaks 6 and opposing troughs 5 in both major surfaces 10 and 12 of the wing, resulting in a wing section which alternates between thick and thin sections. It will be apparent from FIG. 13(c) in particular, that the above described cyclic spanwise variations of the wing illustrated in FIGS. 13 and 13(c) extend substantially chordwise, but disappear at or before reaching the trailing edge 2 of the wing.

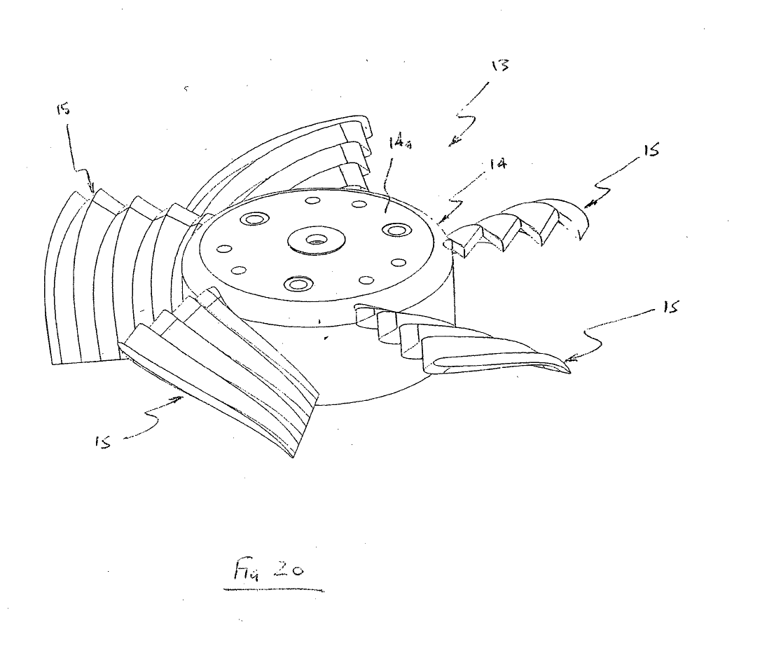

Referring now to FIGS. 14 and 14(d), wherein the cyclic spanwise variations are asymmetric changes in cross-sectional thickness. Here the cyclic spanwise variations form peaks 6 and troughs 5 in the first (or upper) major surface 10, while the second (or lower) major surface 12 incorporates no such cyclic spanwise variations. It will be apparent from FIG. 14(d) in particular, that the above described cyclic spanwise variations of the wing illustrated in FIGS. 14 and 14(d) extend substantially chordwise, but disappear at or before reaching the trailing edge 2 of the wing.

Referring now to FIGS. 15 and 15(e), wherein the cyclic spanwise variations are changes in section camber. Here the cyclic spanwise variations form peaks 6 and troughs 5 in the first (or upper) major surface 10 which are more pronounced than the peaks 6 and troughs 5 in the second (or lower) major surface 12. It will be apparent from FIG. 15(e) in particular, that the above described cyclic spanwise variations of the wing illustrated in FIGS. 15 and 15(e) extend substantially chordwise, but disappear at or before reaching the trailing edge 2 of the wing.

Referring now to FIGS. 16 and 16(f), wherein the cyclic spanwise variations are steps in wing section, as discussed above.

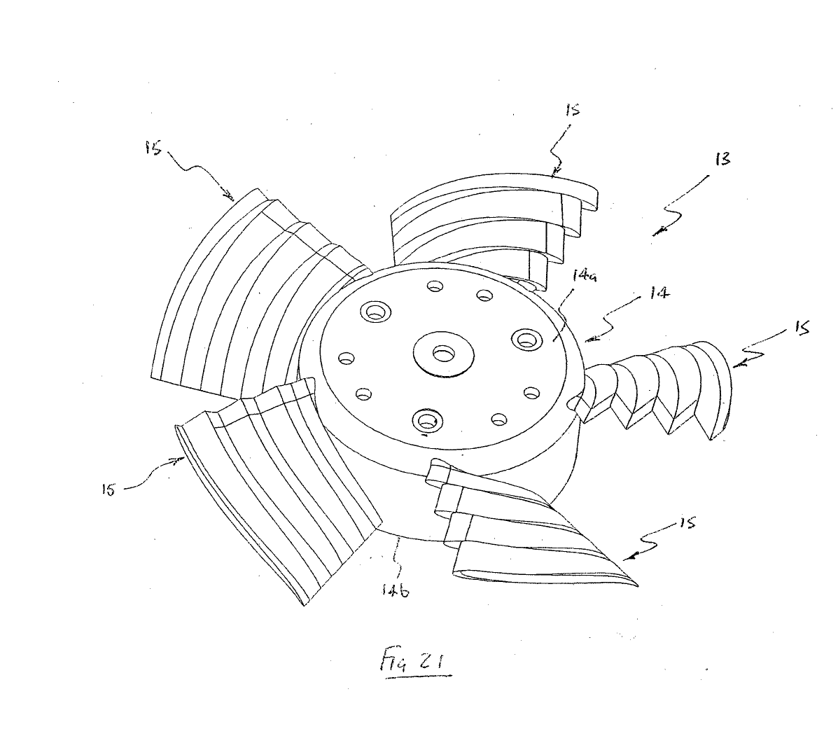

Referring now to FIGS. 17 and 17(g), wherein the cyclic spanwise variations are steps FIGS. 17 and 17(g) extend substantially chordwise, but disappear at or before reaching the trailing edge 2 of the wing.

Referring now to FIG. 19, where the wing embodiment illustrated in FIGS. 4 and 4a, and described above, is employed in a plurality of blades or vanes 15 for an impeller 13 of the type commonly used as a fan for cooling personal computers. The impeller 13 comprises a cylindrical hub 14 to which all of the blades 15 are mounted.

Referring now to FIG. 20, where the wing embodiment illustrated in FIGS. 11 and FIG. 11(a), and described above, is similarly employed in a plurality of blades or vanes for an impeller.

Referring now to FIG. 21, where the wing embodiment illustrated in FIGS. 16 and FIG. 16(t), and described above, is similarly employed in a plurality of blades or vanes for an impeller.

For each of the impellers illustrated in FIGS. 19, 20 and 21, the mean camber line for each blade 15 is concentric to the hub 14 profile, the leading edge for each blade root is mounted close to a front face 14a of the hub 14, and the trailing edge for each blade root is mounted close to a rear face 14b of the hub 14. Each blade root camber line “wraps” the circular hub tangentially and axially.

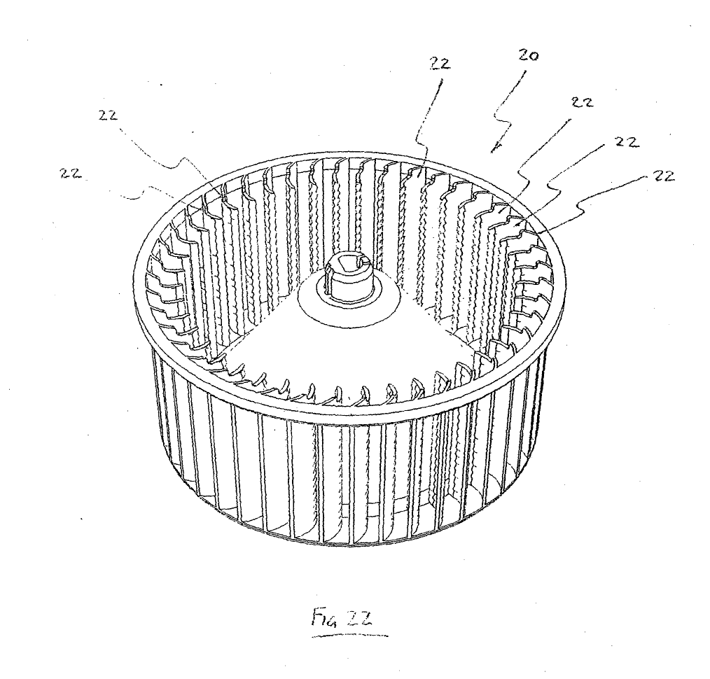

Referring now to FIG. 22, where the wing embodiment illustrated in FIGS. 2 and 4, and described above, is employed in a plurality of blades or vanes 22 for a centrifugal impeller 20.

An advantage of the wings according to the present invention is their suitability for use in impellers incorporating pressed-metal blades. These blades may be made from flat or cambered thin sheet metal, and as such they operate efficiently over a relatively narrow range of flow conditions. The incorporation of waves in the impeller blade according to this invention will broaden the range of efficient operating conditions of the impellers, reducing their tendency to undergo sudden stall and decreasing their aerodynamic noise under all operating conditions.

Each of the above described wings according to the present invention, produce a cyclic spanwise variation in pressure distribution (or lift per unit span), which leads to the formation of stream-wise vortices above the wing without significant additional wing surface area or significant spanwise variation in wing cross sectional shape.

These vortices have been shown to increase the momentum exchange between the free the stall process over a broader range of angles of attack. This leads to a “softer”, less sudden stall characteristic that lends itself to use in devices such as wind turbines and aircraft, where soft stall characteristics are usually desirable.

An additional benefit is that the streamwise vortices decrease the spanwise transport of fluid near the wing tips, thereby decreasing the size of any separation zone near the wing tip and the strength of the wing tip vortices, hence induced drag.

The effect of the present invention is quantifiable in that the lift (hence the local mean pressure difference across the wing) is directly proportional to the effective angle of attack of the aerofoil. During cruise, the angle of attack is typically 3 degrees for modern aircraft. A spanwise cyclic variation in angle of attack of just +/−1 degree will lead to an average pressure difference across the wing that varies by +/−33% along the span. This is sufficient to generate strong streamwise vortices on the top of the aerofoil, hence an increased tendency to maintain attached flow, and a reduced tendency to form a strong wing tip vortex downstream of the wing (hence reduced induced drag).

Induced drag is a significant contributor to the aerodynamic drag of aircraft in particular. The wing tip vortices left behind aircraft, particularly during take-off and landing, are also a significant danger to aircraft that follow. The presence of these tip vortices limits the time period between successive take-offs and landings at airports. Elimination of these tip vortices would allow a four-fold increase (at least) in capacity at large airports, saving billions of dollars per year world-wide.

While induced drag is reduced, the maximum lifting force produced by the wing is increased when compared to conventional wing configurations, so the lift-to-drag ratio is also improved.

A further advantage is that the spanwise cyclic variation in sectional shape reduces the coherence of the velocity fluctuations in the wake of the wing, hence decreasing the acoustic emission from the flow around the wing. For one embodiment a reduction in tonal noise of up to 32 dB and a decrease in the broadband noise of 8 dB have been measured.

In addition to the above, the wing according to the present invention can be configured to generate a disturbance to the flow only where and when it is needed, that is the upper (low pressure) major surface. In contradistinction, the wing disclosed in U.S. Pat. No. 6,431,498 creates a disturbance to flow around both the upper and lower sides of the wing disclosed therein. variations in the pressure distribution along the span, so that only a small spanwise geometric variation is required to produce a large aerodynamic perturbation (the Figures illustrate exaggerated impressions of the shape variations). By comparison, the leading edge scallops of U.S. Pat. No. 6,431,498 do not (or at least not significantly) alter the camber or angle of attack—this document discusses only the leading edge sweep. It is likely that such scallops and/or sweep variations would need to be relatively large in order to produce a significant effect on the flow.

A further difference between the wing according to the present invention and the leading edge scallops of U.S. Pat. No. 6,431,498 is that the strength of the resultant streamwise vortices will be somewhat independent of the angle of attack (in the un-stalled flow condition), whereas for the leading edge scallops of U.S. Pat. No. 6,431,498 the streamwise vortices will be weak at zero angle of attack, and increase in strength as the angle of attack increases.

By comparison, the disclosure of U.S. Pat. No. 4,830,315, describes downstream-extending troughs and ridges that do not extend to the leading edge, and so cannot work as effectively at large angles of attack because they do not extend far enough towards the leading edge. Also, in order to generate the desired effect, these features must be significant in size.

In addition to its numerous benefits and advantages, the wing according to the present invention is applicable to a broad range of applications, including but not limited to aircraft and water craft of any size, wind turbines, racing car wings, submarines, yachts, ships, axial and centrifugal fans, HVAC turning vanes, gas turbine rotors and stators, surfboards, bicycle frames and components, and aeronautical applications where short take-off or landing at slower speed is needed. In wind and water turbines, where the root stall problem is significant, the present invention can reduce the likelihood and extent of root stall due to turbulent flow conditions and also produce a less sudden, more progressive stall process, thereby increasing the fatigue life of the blades.

Tests on 120 mm-diameter axial fan impellers of the type illustrated in FIGS. 19 through 21, with blade modifications according to the present invention, were performed to determine the effect of the modifications on the power consumption at a defined rotational speed. It was found that the best-performing embodiment employs the sinusoidally-varying angle of attack of the type illustrated in FIG. 2. In fact, all of the impellers of this type out-performed the embodiments with scalloped leading edges of the type disclosed in U.S. Pat. No. 6,431,498. Moreover, the best of the sinusoidally-varying angle of attack cases shared the same ratio of amplitude to wavelength ie A/□λ=0.34.

Referring now to FIG. 18, where there is illustrated a wing wherein the cyclic variations 5 and 6 can be concealed beneath a leading edge slat 9 during normal operation, and provide aerodynamic effects only when the leading edge slat 9 is deployed.

In non-illustrated alternatives, the spanwise cyclic variation in sectional shape may be separable from the wing by means of a leading-edge slat. Alternatively, these features may be deployed by actuators within the wing that distort the wing surface shape to produce the desired wing shape profiles. Materials such as shape-memory alloys may be used to achieve such an effect. Alternatively, pockets within the wing surface may be inflated using a fluid such as air, water or oil to achieve such a change in surface shape. The shape-memory alloy possibility would be ideally suited to small unmanned air vehicles, as these vehicles are often too small to use retractable slats and flaps.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A wing comprising a generally aerofoil (or airfoil) shaped body having a leading edge, a trailing edge, a span, and first and second major surfaces extending between the leading edge and the trailing edge, where at least one of said first or second major surfaces comprises cyclic spanwise variations at or near the leading edge thereof, but not the trailing edge thereof.

2. The wing of claim 1, wherein the cyclic spanwise variations extend substantially chordwise from at or near the leading edge, progressively diminishing as they extend chordwise so as to disappear at or before reaching the trailing edge of the wing.

3. The wing as in claim 1, wherein one major surface comprises said cyclic spanwise variations thereof, and the other major surface does not.

4. The wing as in claim 1, wherein both of the first and second major surfaces comprise said cyclic spanwise variations thereof.

5. The wing as in claim 1, wherein said cyclic spanwise variations form peaks and troughs in the or each major surface.

6. The wing of claim 5, wherein a transition between adjacent peaks and troughs is substantially smooth.

7. The wing of claim 5, wherein a transition between adjacent peaks and troughs is substantially linear.

8. The wing as in claim 5, wherein both peaks and troughs in each of the first and second major surfaces are synchronized or in phase with each other.

9. The wing as in claim 5, wherein peaks and troughs in each of the first and second major surfaces are out of phase with each other.

10. The wing of claim 9, wherein peaks in one major surface are synchronized or in phase with troughs in the other major surface.

11. The wing as in claim 1, where the cyclic spanwise variations are variations in angle of attack.

12. The wing as in claim 1, wherein the cyclic spanwise variations are variations in camber.

13. The wing as in claim 1, wherein the cyclic spanwise variations are variations in wing cross-section.

14. The wing as in claim 1, wherein the cyclic spanwise variations are displacements in wing cross-section.

15. The wing as in claim 1, configured to be mounted on a hub for use as an impeller or turbine.

16. An impeller comprising a plurality of blades, each blade having the form of a wing as in claim 1.

17. A propeller comprising a plurality of blades, each blade having the form of a wing as in claim 1.
